(19) United States
(12) Patent Application Publication
(10) Pub. No.: US 2017/0146064 A1
(43) Pub. Date: May 25, 2017

(54) Bearing Assembly with Oil Seal Arrangement

(71) Applicant: Jixian Lyu, Changyi (CN)

(72) Inventors: Jixian Lyu, Changyi (CN); Guangming Pu, Changyi (CN)

(21) Appl. No.: 14/949,856

(22) Filed: Nov. 23, 2015

(51) Int. Cl. F16C 33/66; F16C 19/38; F16C 33/78

(52) U.S. Cl. CPC F16C 33/6655; F16C 33/7896; F16C 19/38

(57) ABSTRACT

A bearing assembly includes a casing, a rotatable shaft disposed in the casing, a bearing unit coaxially coupled between the rotatable shaft and the casing, and an oil seal arrangement. The oil seal arrangement includes an inner sealing member, and an outer sealing member, and an oil filling unit. The inner sealing member is coaxially extended from the rotatable shaft to the casing for enclosing the bearing unit within the casing and for sealing and retaining lubricant within the casing. The outer sealing member is coaxially extended from the rotatable shaft to the casing at a position apart from the inner sealing member to form an oil reserving chamber between the inner and outer sealing members for reserving a predetermined of reserved lubricant. The oil filling unit is formed at the casing to communicate with the oil reserving chamber for refilling the reserved lubricant thereinto.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a bearing assembly, and more particularly to a bearing assembly with an oil seal arrangement, which has an oil reserving chamber formed between an inner sealing member and an outer sealing member for preventing the outer sealing member being worn out so as to prolong the service life span of the bearing assembly.

Description of Related Arts

A conventional bearing assembly generally comprises a bearing casing, a rotatable axle rotatably supported within the bearing casing, and a bearing unit supported around the rotatable axle within the bearing casing for ensuring the rotational movement of the rotatable axle. In particular, the bearing assembly further comprises an oil seal for retaining a predetermined amount of lubricant within the bearing casing to reduce a friction of the rotatable axle and heat during the rotational movement. However, the major drawback of the conventional bearing assembly is the oil leakage problem through the oil seal due to the heat, overload, and impact of the rotatable axle during the rotational movement.

An improved bearing assembly further comprises a double oil seal structure to minimize the oil leakage problem. Accordingly, the double oil seal structure comprises an inner seal and an outer seal, wherein the lubricant will be blocked by the outer seal when the lubricant leaks through the inner seal to ensure the normal operation of the bearing assembly. However, an oil film must be provided between the outer circumferential surface of the rotatable axle and the inner edge of the outer seal to enable the rotational movement of the rotatable axle within the outer seal. Since the outer seal is exposed to the exterior environment, the outer seal will be worn out faster than the inner seal. The oil film will be dried or evaporated due to the environment. In other words, once the lubricant leaks through the inner seal, the lubricant will eventually leaks through the worn outer seal as well. As a result, the double oil seal structure cannot effectively prevent the oil leakage problem of the bearing assembly.

### SUMMARY OF THE PRESENT INVENTION

The invention is advantageous in that it provides a bearing assembly with an oil seal arrangement, which has an oil reserving chamber formed between an inner sealing member and an outer sealing member for preventing the outer sealing member being worn out so as to prolong the service life span of the bearing assembly.

Another advantage of the invention is to a bearing assembly with an oil seal arrangement, wherein the lubricant in the oil reserving chamber is refillable to keep the lubrication of the inner sealing member.

Another advantage of the invention is to a bearing assembly with an oil seal arrangement, wherein the fixing seal is sealed and mounted at the inner sealing member to ensure the outer circumferential edge of the inner sealing member to be immovably sealed at the inner circumferential surface of the casing, so as to prevent any unwanted movement of the outer circumferential edge of the inner sealing member due to the high interior pressure of the casing.

Another advantage of the invention is to a bearing assembly with an oil seal arrangement, wherein the lubricant in the oil reserving chamber is separated from the lubricant in the casing, such that chemical proprieties of the lubricant in the oil reserving chamber will not be changed due to the heat, overload, and impact of the rotatable shaft, so as to prolong the service life span of the lubricant in the oil reserving chamber.

Another advantage of the invention is to a bearing assembly with an oil seal arrangement, wherein the inner and outer sides of the inner sealing member are lubricated by the lubricant in the casing and in the oil reserving chamber to prolong the service life span of the inner sealing member.

Another advantage of the invention is to a bearing assembly with an oil seal arrangement, wherein the inner and outer sides of the outer sealing member are lubricated by the lubricant in the oil reserving chamber and the grease to prolong the service life span of the outer sealing member.

Another advantage of the invention is to a bearing assembly with an oil seal arrangement, wherein the oil seal arrangement is easy to assemble or disassemble with the casing to enhance the sealing effect of the bearing assembly.

Another advantage of the invention is to a bearing assembly with an oil seal arrangement, which does not require to alter the original structural design of the bearing assembly, so as to minimize the manufacturing cost of the bearing assembly incorporating with the oil seal arrangement.

Another advantage of the invention is to a bearing assembly with an oil seal arrangement, wherein no expensive or complicated structure is required to employ in the present invention in order to achieve the above mentioned objects. Therefore, the present invention successfully provides an economic and efficient solution for providing a sealing configuration for the bearing assembly.

Additional advantages and features of the invention will become apparent from the description which follows, and may be realized by means of the instrumentalities and combinations particular point out in the appended claims.

According to the present invention, the foregoing and other objects and advantages are attained by a bearing assembly which comprises a casing, a rotatable shaft disposed in the casing, and a bearing unit coaxially coupled between the rotatable shaft and the casing.

The bearing assembly further comprises an oil seal arrangement which comprises an inner sealing member, and an outer sealing member, and an oil filling unit. The inner sealing member is coaxially extended from the rotatable shaft to the casing for enclosing the bearing unit within the casing and for sealing and retaining lubricant within the casing. The outer sealing member is coaxially extended from the rotatable shaft to the casing at a position apart from the inner sealing member to form an oil reserving chamber between the inner and outer sealing members for reserving a predetermined of reserved lubricant. The oil filling unit is formed at the casing to communicate with the oil reserving chamber for refilling the reserved lubricant thereinto.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a partially sectional view of a bearing assembly with an oil seal arrangement according to a preferred embodiment of the present invention.

FIG. 2 is a perspective view of a first modification of the bearing assembly with the oil seal arrangement according to the preferred embodiment of the present invention.

FIG. 3 is a sectional view of the first modification of the bearing assembly with the oil seal arrangement according to the preferred embodiment of the present invention.

FIG. 4 is a sectional view of the oil seal arrangement of the first modification of the bearing assembly according to the preferred embodiment of the present invention.

FIG. 5 is a side view of a second modification of the bearing assembly with the oil seal arrangement according to the preferred embodiment of the present invention.

FIG. 6 is a sectional view of the second modification of the bearing assembly with the oil seal arrangement according to the preferred embodiment of the present invention.

FIG. 7 is a sectional view of the oil seal arrangement of the second modification of the bearing assembly according to the preferred embodiment of the present invention.

FIG. 8 is a perspective view of the annular brim of the oil seal arrangement of the second modification of the bearing assembly according to the preferred embodiment of the present invention.

FIG. 9 is a perspective view of a third modification of the bearing assembly with the oil seal arrangement according to the preferred embodiment of the present invention.

FIG. 10 is a sectional view of the third modification of the bearing assembly with the oil seal arrangement according to the preferred embodiment of the present invention.

FIG. 11 is a sectional view of the oil seal arrangement of the third modification of the bearing assembly according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

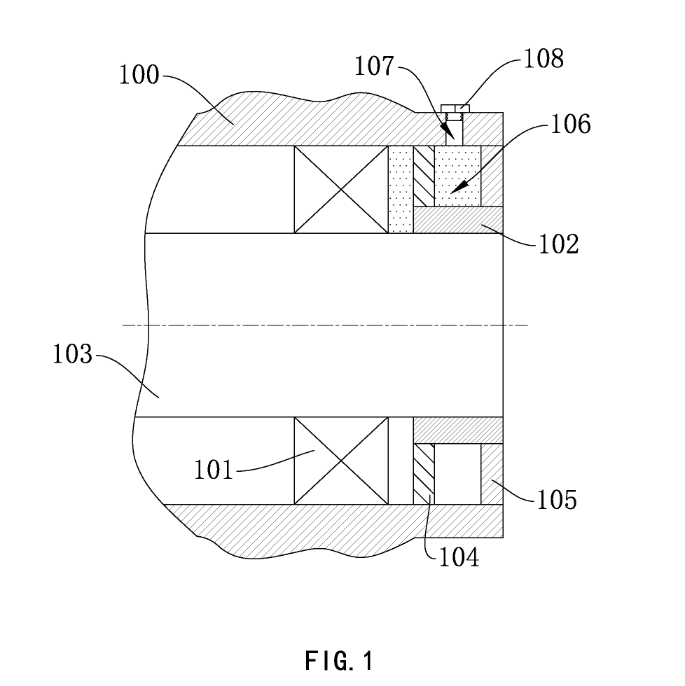

Referring to FIG. 1 of the drawings, a bearing assembly according to a preferred embodiment of the present invention is illustrated, wherein the bearing assembly comprises a casing 100, a rotatable shaft 103, at least a bearing unit 101, and an oil seal arrangement.

The casing 100 has a tubular shape which has a closed end and an opposed open end. Accordingly, the casing 100 has a casing cavity formed within an inner circumferential surface thereof.

The rotatable shaft 103 is rotatably disposed within the casing cavity of the casing 100, wherein the rotatable shaft 103 is coaxially supported within the casing 100 at a center thereof. The bearing unit 101 is coaxially coupled between the rotatable shaft 103 and the casing 100. Preferably, an outer side of the bearing unit 101 contacts with the inner circumferential surface of the casing 100 and the inner side of the bearing unit 101 contacts with the outer circumferential surface of the rotatable shaft 103, such that the bearing unit 101 enables a smooth rotational movement of the rotatable shaft 103 within the casing 100.

The oil seal arrangement comprises an inner sealing member 104 and an outer sealing member 105. The inner sealing member 104 is coaxially extended from the rotatable shaft 103 to the casing 100 for enclosing the bearing unit 101 within the casing 100 and for sealing and retaining lubricant within the casing 100. Accordingly, the bearing unit 101 and the rotatable shaft 103 are lubricated by the lubricant within the casing 100 which is blocked by the inner sealing member 104.

The outer sealing member 105 is coaxially extended from the rotatable shaft 103 to the casing 100 at a position apart from the inner sealing member 104 to form an oil reserving chamber 106 between the inner and outer sealing members 104, 105 for reserving a predetermined of reserved lubricant. Preferably, grease is applied at the outer side of the outer sealing member 105.

Accordingly, the inner and outer sealing members 104, 105 can be identical or different in shape depending the shape of the opening end of the casing 100. In addition, the inner and outer sealing members 104, 105 can be made of same or different materials. However, the inner and outer sealing members 104, 105 must have a sealing ability for preventing the leak of the lubricant.

It is worth mentioning that the inner and outer sides of the inner sealing member 104 are lubricated by the lubricant in the casing 100 and in the oil reserving chamber 106 to prolong the service life span of the inner sealing member 104. The service life span of the inner sealing member 104 of the present invention can be prolonged at least 5 to 7 times comparing with the conventional sealing member. In addition, the inner and outer sides of the outer sealing member 105 are lubricated by the lubricant in the oil reserving chamber 106 and the grease to prolong the service life span of the outer sealing member 105. The service life span of the outer sealing member 105 of the present invention can be prolonged at least 3 to 7 times comparing with the conventional sealing member.

Accordingly, the reserved lubricant can be the same as the lubricant within the casing 100. It is worth mentioning that the lubricant in the oil reserving chamber 106 is separated from the lubricant in the casing 100, such that chemical proprieties of the lubricant, such as the polymer properties and integrated polymer chain, in the oil reserving chamber 106 will not be changed due to the heat, overload, and impact of the rotatable shaft 103, so as to prolong the service life span of the lubricant in the oil reserving chamber 106. The service life span of the lubricant in the oil reserving chamber 106 of the present invention can be prolonged at least 3 to 7 times comparing with the lubricant in the casing 100. It is worth mentioning that in case of oil leakage of the inner sealing member 104, the lubricant in the oil reserving chamber 106 will fill into the casing 100 to complement the loss of lubricant in the casing 100.

According to the preferred embodiment, the oil seal arrangement further comprises an annular seal 102 coaxially coupled at the rotatable shaft 103 to enable the rotatable shaft 103 to be rotated within the annular seal 102. As shown in FIG. 1, the annular seal 102 has an inner circumferential surface contacts with the outer circumferential surface of the rotatable shaft 103, wherein the inner and outer sealing members 104, 105 are biased against an outer circumferential surface of the annular seal 102. In other words, the inner and outer sealing members 104, 105 are coaxially and spacedly coupled between the annular seal and the casing 100. As shown in FIG. 1, the oil reserving chamber 106 within the inner and outer sealing members 104, 105, the annular seal 102, and the casing 100. It is worth mentioning that the upper section of FIG. 1 shows the lubricant in the casing 100 and the oil reserving chamber 106 and the lower section of FIG. 1 shows there is no lubricant in the casing 100 and the oil reserving chamber 106.

As shown in FIG. 1, an inner circumferential edge of each of the inner and outer sealing members 104, 105 is biased against the outer circumferential surface of the annular seal 102 and an outer circumferential edge of each of the inner and outer sealing members 104, 105 is biased against the inner circumferential surface of the casing 100.

Preferably, a width of the oil reserving chamber 106 is defined as a distance between the inner and outer sealing members 104, 105. In particular, the distance between the inner and outer sealing members 104, 105 is selectively adjusted via a width of the annular seal 102. In other words, when the inner and outer sealing members 104, 105 are moved to two side edge portions of the annular seal 102, the width of the oil reserving chamber 106 will be enlarged.

According to the preferred embodiment, the oil seal arrangement further comprises an oil filling unit formed at the casing 100 to communicate with the oil reserving chamber 106 for refilling the reserved lubricant thereinto. The oil filling unit has a filling channel 107 formed at the casing 100 close to the open end thereof to communicate with the oil reserving chamber 106 and comprises a channel plug 108 operatively coupled at the filling channel 107. Accordingly, the channel plug 108 is detachably coupled at the casing 100 to close the filling channel 107 for retaining the reserved lubricant within the oil reserving chamber 106 and to open the filling channel 107 for filling the reserved lubricant in the oil reserving chamber 106. Therefore, the operator is able to check the amount of the reserved lubricant in the oil reserving chamber 106 via the oil filling unit to ensure the lubrication for the bearing assembly. It is worth mentioning that having the double sealing structure of the oil seal arrangement, the service life span of the bearing assembly of the present invention can be prolonged at least 5 to 7 times comparing with the bearing assembly with conventional oil seal.

As shown in FIG. 1, the filling channel 107 has an inner threaded section formed close to the outer circumferential surface of the casing 100, wherein the channel plug 108 has an outer threaded section to detachably and rotatably engage with the inner threaded section of the filling channel 107. In particular, the channel plug 108 has an enlarged head portion and an elongated body portion extended therefrom, wherein the outer threaded section is formed at the body portion of the channel plug 108, such that the body portion of the channel plug 108 is engaged with the filling channel 107 until the head portion of the channel plug 108 is biased against the outer circumferential surface of the casing 100.

In order to install the oil seal arrangement of the present invention to the bearing assembly, the present invention provides an assembling method which comprises the following steps.

(1) Dispose the rotatable shaft 103 and fill the lubricant within the casing 100.

(2) Coaxially couple the bearing unit 101 between the rotatable shaft 103 and the casing 100.

(3) Coaxially couple the annular seal 102 at the rotatable shaft 103.

(4) Coaxially couple the inner and outer sealing members 104, 105 in the casing 100 to form the oil reserving chamber 106. Accordingly, the inner circumferential edges of the inner and outer sealing members 104, 105 are spacedly biased against the outer circumferential surface of the annular seal 102 and the outer circumferential edges of the inner and outer sealing members 104, 105 are spacedly biased against the inner circumferential surface of the casing 100. It is worth mentioning that the filling channel 107 is formed at the casing 100 between the inner and outer sealing members 104, 105. In addition, grease is preferably applied at the outer side of the outer sealing member 105.

(5) Filling the reserved lubricant into the oil reserving chamber 106 through the filling channel 107.

(6) Close the filling channel 107 by the channel plug 108 to reserve the reserved lubricant into the oil reserving chamber 106.

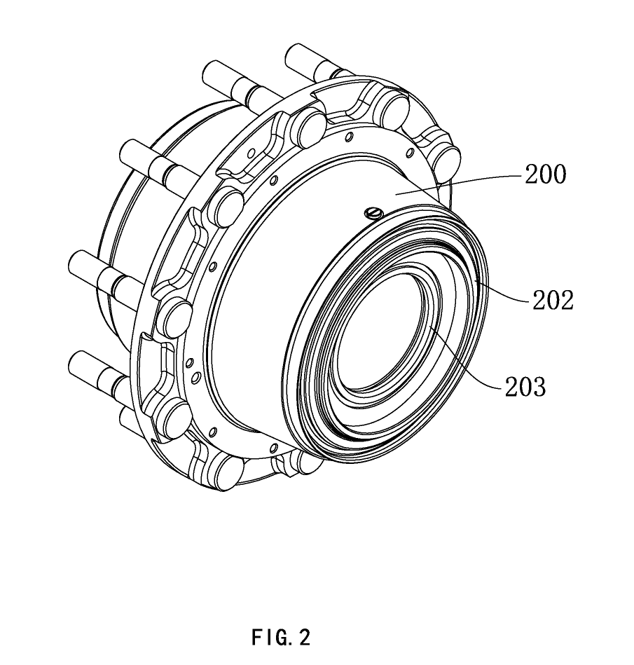

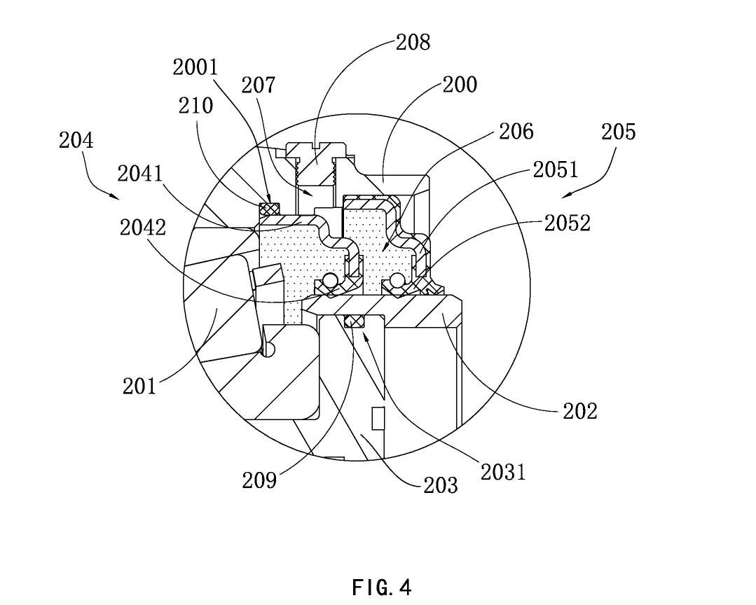

FIGS. 2 to 4 illustrate a first modification of the bearing assembly which has the similar structural configuration of the bearing assembly, wherein the first modification of the bearing assembly comprises the casing 200, the rotatable shaft 203, the bearing unit 201, and the oil seal arrangement which comprises the annular seal 202, the inner sealing member 204, and the outer sealing member 205 to form the oil reserving chamber 206. The oil filling unit has the filling channel 207 formed at the casing 200 close to the open end thereof to communicate with the oil reserving chamber 206 and comprises the channel plug 208 operatively coupled at the filling channel 207. As shown in FIG. 4, the oil reserving chamber 206 within the inner and outer sealing members 204, 205, the annular seal 202, and the casing 200.

According to the first modification of the bearing assembly, the shape of the inner sealing member 204 is different from the shape of the outer sealing member 205. The shapes of the inner and outer sealing members 204, 205 are configured to match with the contour of the open end of the casing 200.

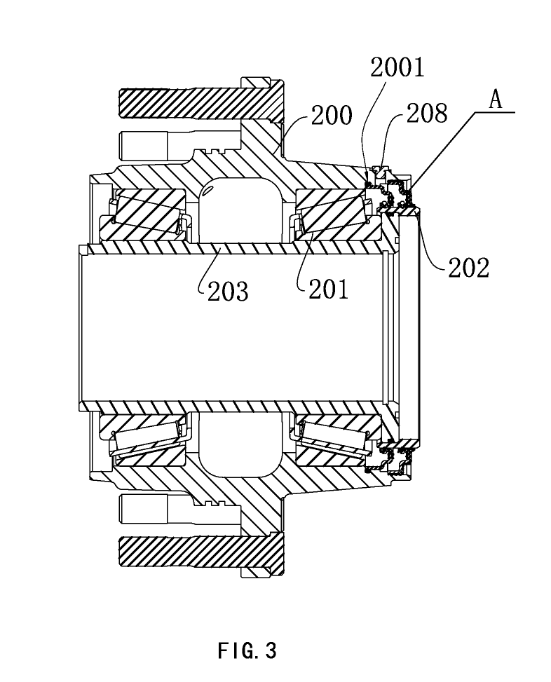

As shown in FIGS. 3 and 4, the oil seal arrangement further comprises a sealing element 209 sealed and mounted between the annular seal 202 and the rotatable shaft 203 for enhancing the sealing effect therebetween. The sealing element 209 has a ring shape that the width of the sealing element 209 is smaller than the width of the annular seal 202. In addition, the rotatable shaft 203 further has an annular indentation 2031 indent on an outer circumferential surface at the outer end of the rotatable shaft 203, wherein the sealing element 209 is received at the annular indentation 2031, such that the annular seal 202 not only contacts with the outer circumferential surface of the rotatable shaft 203 but also contacts with the outer circumferential surface of the sealing element 209 to enhance a sealing effect of the annular seal 202 especially when the rotatable shaft 203 can be rotated within the annular seal 202. It is worth mentioning that the sealing element 209 can be an oil film sealed and mounted between the annular seal 202 and the rotatable shaft 203, such that the rotatable shaft 203 can be rotated within the annular seal 202.

According to the first modification of the bearing assembly, the inner sealing member 204 comprises a first inner sealer 2041 and a second inner sealer 2042 extended from the first inner sealer 2041 end-to-end. The first inner sealer 2041 is preferably made of rigid material that biases against the inner circumferential surface of the casing 200. The second inner sealer 2042 is preferably made of elastic material that biases against the outer circumferential surface of the annular seal 202. In other words, the outer circumferential edge of the inner sealing member 204 forms at an outer circumferential edge of the first inner sealer 2041 while the inner circumferential edge of the inner sealing member 204 forms at an inner circumferential edge of the second inner sealer 2042. Preferably, a length of the first inner sealer 2041 is longer than a length of the second inner sealer 2042.

The outer sealing member 205 comprises a first outer sealer 2051 and a second outer sealer 2052 overlapped on the first outer sealer 2051. Preferably, a length of the first outer sealer 2051 is shorter than a length of the second outer sealer 2052. The first outer sealer 2051 is preferably made of rigid material and the second outer sealer 2052 is preferably made of elastic material. Therefore, the outer circumferential edge of the outer sealing member 205 forms at an outer circumferential edge of the first and second outer sealers 2051 to bias against the inner circumferential surface of the casing 200 while the inner circumferential edge of the outer sealing member 205 forms at an inner circumferential edge of the second outer sealer 2052 to bias against the outer circumferential surface of the annular seal 102.

Furthermore, the oil seal arrangement further comprises a fixing seal 210 sealed and mounted at the outer circumferential edge of the inner sealing member 204 to ensure the outer circumferential edge of the inner sealing member 204 to be immovably sealed at the inner circumferential surface of the casing 200. As shown in FIG. 3, the fixing seal 210 is sealed and mounted between the inner circumferential surface of the casing 200 and the outer circumferential edge of the first inner sealer 2041 of the inner sealing member 204. The fixing seal 210 has a ring shape that the width of the fixing seal 210 is smaller than the width of the outer circumferential edge of the first inner sealing member 204. As shown in FIG. 3, the casing 200 further has a casing annular indentation 2001 indent on the inner circumferential surface of the casing 200, wherein the fixing seal 201 is received at the casing annular indentation 2001, such that the outer circumferential edge of the inner sealing member 204 not only contacts with the inner circumferential surface of the casing 200 but also contacts with the inner circumferential surface of the fixing seal 210 to enhance a sealing effect of the inner sealing member 204. It is worth mentioning that the fixing seal 210 can be an oil film sealed and mounted between the inner sealing member 204 and the casing 200.

In order to install the first modification of the oil seal arrangement to the bearing assembly, before the step (3), the present invention further comprises the following steps.

(A) Seal and mount the sealing element 209 between the annular seal 202 and the rotatable shaft 203.

(B) Seal and mount the fixing seal 210 at the outer circumferential edge of the inner sealing member 204.

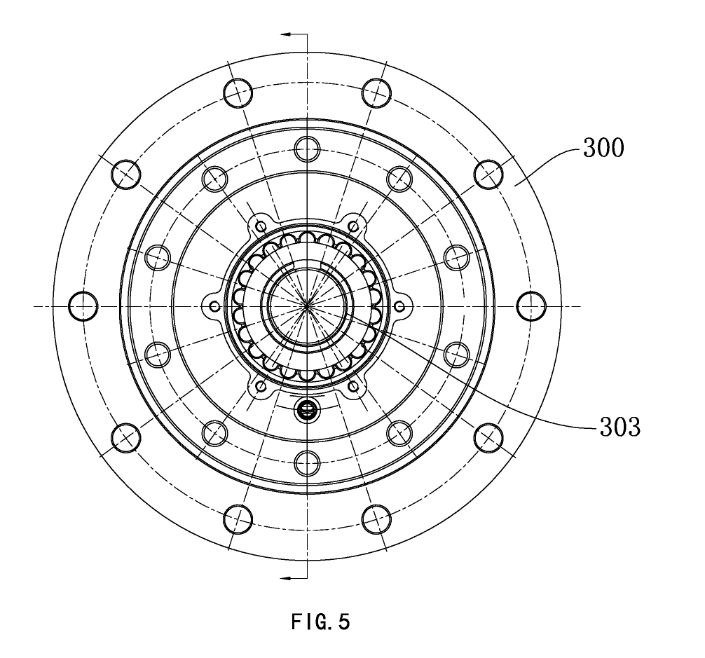

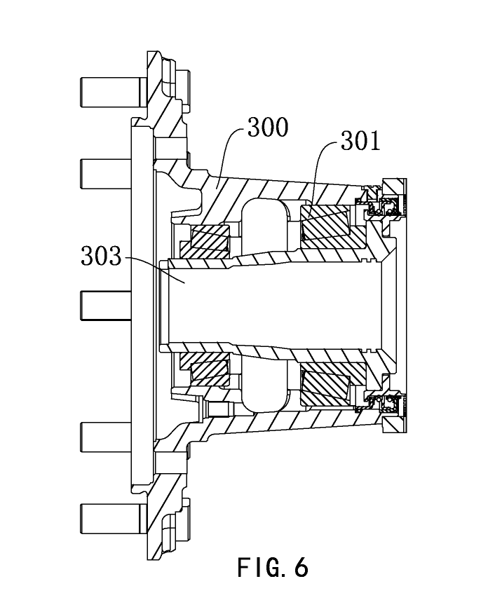

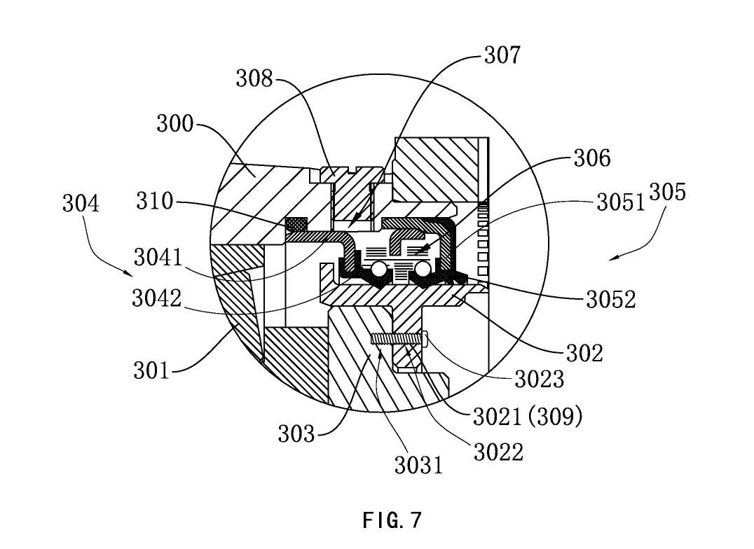

FIGS. 5 to 8 illustrate a second modification of the bearing assembly which has the similar structural configuration of the first modification of the bearing assembly, wherein the first modification of the bearing assembly comprises the casing 300, the rotatable shaft 303, the bearing unit 301, and the oil seal arrangement which comprises the annular seal 302, the inner sealing member 304, and the outer sealing member 305 to form the oil reserving chamber 306. The oil filling unit has the filling channel 307 formed at the casing 300 close to the open end thereof to communicate with the oil reserving chamber 306 and comprises the channel plug 308 operatively coupled at the filling channel 307. As shown in FIG. 7, the oil reserving chamber 306 within the inner and outer sealing members 304, 305, the annular seal 302, and the casing 300.

In addition, the structural configuration of the inner sealing member 304 has the same as the first modification that the inner sealing member 304 comprises the first inner sealer 3041 and the second inner sealer 3042, wherein the fixing seal 310 sealed and mounted at the outer circumferential edge of the inner sealing member 304. Likewise, the outer sealing member 305 also comprises the first outer sealer 3051 and the second outer sealer 3052.

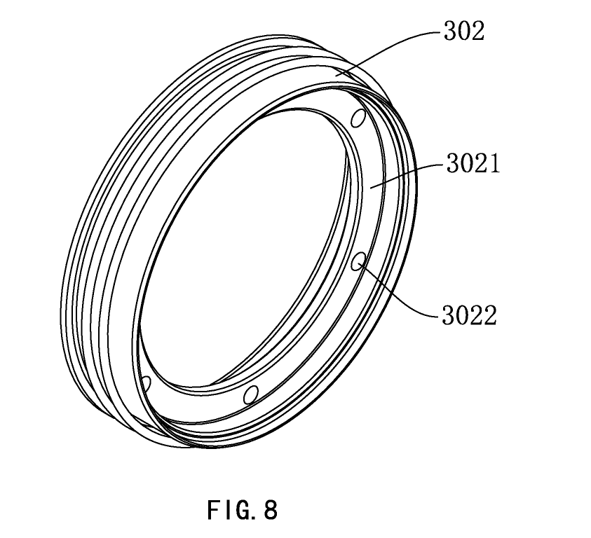

As shown in FIGS. 7 and 8, the major modification for the second modification is that the sealing element 309 is integrally and radially extended from the annular seal 302 to form an annular brim 3021 thereof to bias against an outer end of the rotatable shaft 303, wherein a plurality of affixing holes 3022 are spacedly formed along the annular brim 3021 for detachably affixing the annular brim 3021 at the outer end of the rotatable shaft 303 via a plurality of fasteners 3023. Accordingly, a plurality of coupling holes 3031 are spacedly formed at the outer end of the rotatable shaft 303 to align with the affixing holes 3022 respectively, such that the fasteners 3023 are engaged with the coupling holes 3031 through the affixing holes 3022 respectively to fasten the annular brim 3021 at the outer end of the rotatable shaft 303.

In order to install the second modification of the oil seal arrangement to the bearing assembly, in the step (4), the present invention further comprises the following step.

(4.1) Fasten the annular brim 3021 at the outer end of the rotatable shaft 303 via the fasteners.

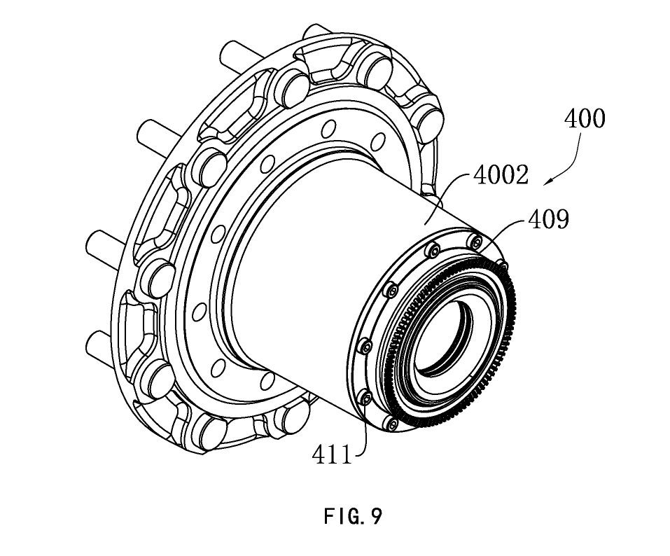

FIGS. 9 to 11 illustrate a second modification of the bearing assembly which has the similar structural configuration of the first modification of the bearing assembly, wherein the first modification of the bearing assembly comprises the casing 400, the rotatable shaft 403, the bearing unit 401, and the oil seal arrangement which comprises the annular seal 402, the inner sealing member 404, and the outer sealing member 405 to form the oil reserving chamber 406. The oil filling unit has the filling channel 407 formed at the casing 400 close to the open end thereof to communicate with the oil reserving chamber 406 and comprises the channel plug 408 operatively coupled at the filling channel 407.

In addition, the structural configuration of the inner sealing member 404 has the same as the first modification that the inner sealing member 404 comprises the first inner sealer 4041 and the second inner sealer 4042. Likewise, the outer sealing member 405 also comprises the first outer sealer 4051 and the second outer sealer 4052. The sealing element 409 is received at the annular indentation 4031, wherein the sealing element 409 sealed and mounted between the annular seal 402 and the rotatable shaft 403.

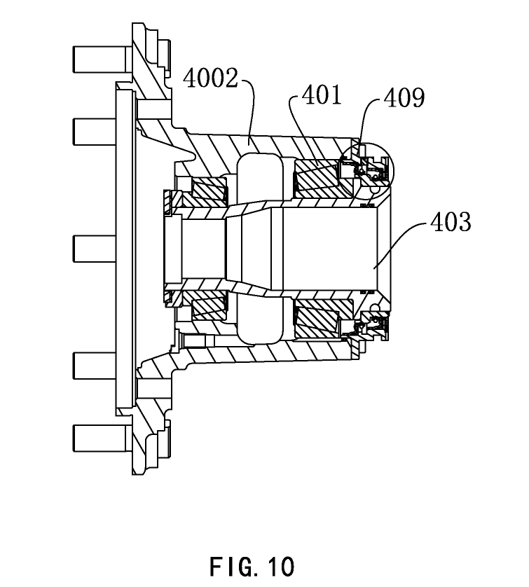

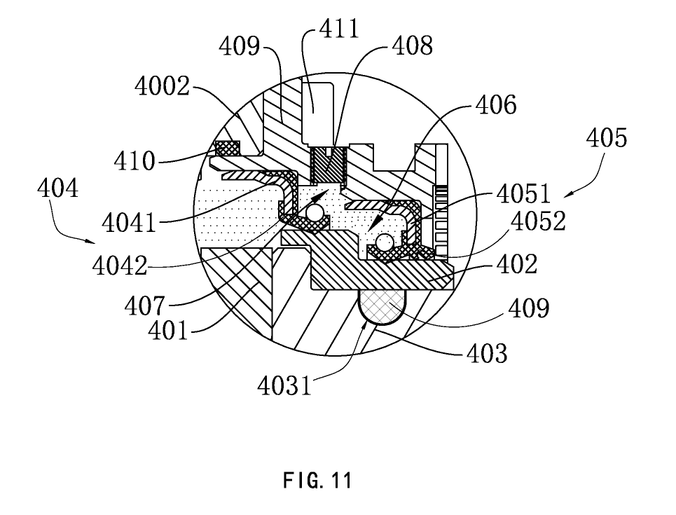

As shown in FIGS. 10 and 11, the major modification for the third modification is that the casing 400 comprises a casing body 4002 having an open end, and an annular seat 409 detachably coupled at the open end of the casing body 4002 via a plurality of casing fasteners 411. The annular seat 409 is made of rigid material, such as acrylonitrile butadiene styrene (ABS) to provide strength and rigidity at the open end of the casing body 4002. According to the third modification, the filling channel 407 is formed at the circumferential surface of the annular seat 409 of the casing 400, wherein the channel plug 408 is detachably coupled at the annular seat 409 of the casing 400 to close or open the filling channel 407.

As shown in FIG. 11, the inner and outer sealing members 404, 405 are biased against an inner circumferential surface of the annular seat 409 to form the oil reserving chamber 406 between the inner and outer sealing members 404, 405. As shown in FIG. 11, the oil reserving chamber 106 within the inner and outer sealing members 404, 405, the annular seal 402, and the annular seat 409 of the casing 400.

According to the third modification, the oil seal arrangement further comprises a seat sealing member 410 sealed and mounted between the casing body 4002 and the annular seat 409 for preventing the lubricant being leaked therethrough. The seat sealing member 410 has a ring shape embedded in the inner circumferential surface of the casing body 4002. In particular, the casing 400 further has a casing annular indentation 4001 indent on the inner circumferential surface of the casing body 4002, wherein the seat sealing member 410 is received at the casing annular indentation 4001.

In order to install the third modification of the oil seal arrangement to the bearing assembly, before the step (1), the present invention further comprises the steps of mounting the seat sealing member 410 at the casing annular indentation 4001, and fastening the annular seat 409 with the casing body 4002.

According to the present invention, the bearing assembly according to the preferred embodiment and its modifications can be interchangeable. When the reserved lubricant is filled into the oil reserving chamber 106, 206, 306, 406 through the filling channel 107, 207, 307, 407, the inner sealing member 104, 204, 304, 404 and the outer sealing member 105, 205, 305, 405 are lubricated to prolong the service life span of the bearing assembly. It is worth mentioning that the assembling process of the oil seal arrangement is simply and easy, such that when any one of the components is broken, oil seal arrangement can be simply detached from the casing for replacement.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A bearing assembly, comprising:
a casing;
a rotatable shaft disposed in said casing;
a bearing unit coaxially coupled between said rotatable shaft and said casing; and
an oil seal arrangement which comprises:
an inner sealing member coaxially extended from said rotatable shaft to said casing for enclosing said bearing unit within said casing and for sealing and retaining lubricant within said casing;
an outer sealing member coaxially extended from said rotatable shaft to said casing at a position apart from said inner sealing member to form an oil reserving chamber between said inner and outer sealing members for reserving a predetermined of reserved lubricant; and
an oil filling unit formed at said casing to communicate with said oil reserving chamber for refilling the reserved lubricant thereinto.

2. The bearing assembly, as recited in claim 1, wherein said oil filling unit has a filling channel formed at said casing to communicate with said oil reserving chamber and comprises a channel plug operatively coupled at said filling channel to selectively close said filling channel for retaining said reserved lubricant within said oil reserving chamber and to open said filling channel for filling said reserved lubricant in said oil reserving chamber.

3. The bearing assembly, as recited in claim 1, wherein said oil seal arrangement further comprises an annular seal coaxially coupled at said rotatable shaft to enable said rotatable shaft to be rotated within said annular seal, wherein said inner and outer sealing members are coaxially and spacedly coupled between said annular seal and said casing.

4. The bearing assembly, as recited in claim 2, wherein said oil seal arrangement further comprises an annular seal coaxially coupled at said rotatable shaft to enable said rotatable shaft to be rotated within said annular seal, wherein said inner and outer sealing members are coaxially and spacedly coupled between said annular seal and said casing.

5. The bearing assembly, as recited in claim 3, wherein an inner circumferential edge of each of said inner and outer sealing members is biased against an outer circumferential surface of said annular seal and an outer circumferential edge of each of said inner and outer sealing members is biased against an inner circumferential surface of said casing.

6. The bearing assembly, as recited in claim 4, wherein an inner circumferential edge of each of said inner and outer sealing members is biased against an outer circumferential surface of said annular seal and an outer circumferential edge of each of said inner and outer sealing members is biased against an inner circumferential surface of said casing.

7. The bearing assembly, as recited in claim 4, wherein said oil seal arrangement further comprises a sealing element sealed and mounted between said annular seal and said rotatable shaft, such that said annular seal not only contacts with said rotatable shaft but also contacts with said sealing element to enhance a sealing effect of said annular seal.

8. The bearing assembly, as recited in claim 6, wherein said oil seal arrangement further comprises a sealing element sealed and mounted between said annular seal and said rotatable shaft, such that said annular seal not only contacts with said rotatable shaft but also contacts with said sealing element to enhance a sealing effect of said annular seal.

9. The bearing assembly, as recited in claim 7, wherein said rotatable shaft further has an annular indentation indent on an outer circumferential surface, wherein said sealing element is received at said annular indentation.

10. The bearing assembly, as recited in claim 8, wherein said rotatable shaft further has an annular indentation indent on an outer circumferential surface, wherein said sealing element is received at said annular indentation.

11. The bearing assembly, as recited in claim 7, wherein said sealing element is integrally and radially extended from said annular seal to form an annular brim thereof to bias against an outer end of said rotatable shaft, wherein a plurality of affixing holes are spacedly formed along said annular brim for detachably affixing said annular brim at said outer end of said rotatable shaft via a plurality of fasteners.

12. The bearing assembly, as recited in claim 8, wherein said sealing element is integrally and radially extended from said annular seal to form an annular brim thereof to bias against an outer end of said rotatable shaft, wherein a plurality of affixing holes are spacedly formed along said annular brim for detachably affixing said annular brim at said outer end of said rotatable shaft via a plurality of fasteners.

13. The bearing assembly, as recited in claim 4, wherein said oil seal arrangement further comprises a fixing seal sealed and mounted at said outer circumferential edge of said inner sealing member to ensure said outer circumferential edge of said inner sealing member to be immovably sealed at said inner circumferential surface of said casing.

14. The bearing assembly, as recited in claim 8, wherein said oil seal arrangement further comprises a fixing seal sealed and mounted at said outer circumferential edge of said inner sealing member to ensure said outer circumferential edge of said inner sealing member to be immovably sealed at said inner circumferential surface of said casing.

15. The bearing assembly, as recited in claim 1, wherein said casing comprises a casing body having an open end, and an annular seat detachably coupled at said open end of said casing body, wherein said inner and outer sealing members are biased against an inner circumferential surface of said annular seat to form said oil reserving chamber between said inner and outer sealing members.

16. The bearing assembly, as recited in claim 4, wherein said casing comprises a casing body having an open end, and an annular seat detachably coupled at said open end of said casing body, wherein said inner and outer sealing members are biased against an inner circumferential surface of said annular seat to form said oil reserving chamber between said inner and outer sealing members.

17. The bearing assembly, as recited in claim 6, wherein said casing comprises a casing body having an open end, and an annular seat detachably coupled at said open end of said casing body, wherein said inner and outer sealing members are biased against an inner circumferential surface of said annular seat to form said oil reserving chamber between said inner and outer sealing members.

18. The bearing assembly, as recited in claim 15, wherein said oil seal arrangement further comprises a seat sealing member sealed and mounted between said casing body and said annular seat for preventing said lubricant being leaked therethrough.

19. The bearing assembly, as recited in claim 16, wherein said oil seal arrangement further comprises a seat sealing member sealed and mounted between said casing body and said annular seat for preventing said lubricant being leaked therethrough.

20. The bearing assembly, as recited in claim 17, wherein said oil seal arrangement further comprises a seat sealing member sealed and mounted between said casing body and said annular seat for preventing said lubricant being leaked therethrough.
